(19) United States
(12) Patent Application Publication
(10) Pub. No.: US 2024/0194380 A1
(43) Pub. Date: Jun. 13, 2024

(54) R-T-B BASED PERMANENT MAGNET MATERIAL, PREPARATION METHOD THEREFOR AND USE THEREOF

(71) Applicant: YANTAI ZHENGHAI MAGNETIC MATERIAL CO., LTD., Yantai (CN)

(72) Inventors: Yongjiang YU, Yantai (CN); Meng LI, Yantai (CN); Yunying JIANG, Yantai (CN); Lei LIU, Yantai (CN); Tao REN, Yantai (CN)

(21) Appl. No.: 18/536,724

(22) Filed: Dec. 12, 2023

(30) Foreign Application Priority Data
Dec. 13, 2022 (CN) 202211600047.2

(51) Int. Cl. H01F 1/057; B22F 1/16; B22F 3/16; B22F 3/24; B22F 9/02; B22F 9/04; C22C 33/04; C22C 38/00; C22C 38/06; C22C 38/10; C22C 38/14; C22C 38/16

(52) U.S. Cl. CPC H01F 1/0577; B22F 1/16; B22F 3/16; B22F 3/24; B22F 9/023; B22F 9/04; C22C 33/04; C22C 38/002; C22C 38/005; C22C 38/06; C22C 38/10; C22C 38/14; C22C 38/16; B22F 2003/242; B22F 2003/248; B22F 2009/044; B22F 2201/20; B22F 2202/05; B22F 2301/355; B22F 2302/25; B22F 2302/253; B22F 2998/10; B22F 2999/00; C22C 2202/02

(57) ABSTRACT

An R-T-B based permanent magnet material, a preparation method therefor and use thereof are provided. The R-T-B permanent magnet material forms M oxides at the grain boundary triple point, such that oxygen is enriched at the grain boundary triple point, thereby accurately controlling the oxygen content in the magnet. The permanent magnet material and the preparation method of the present disclosure can prepare products with strong corrosion resistance under the condition of unchanged magnetic properties, and improve the formability in the pressing process, thereby improving the qualified rate of the products.

The present application claims priority to the prior patent application with the application No. 202211600047.2 and entitled “R-T-B BASED PERMANENT MAGNET MATERIAL, PREPARATION METHOD THEREFOR AND USE THEREOF”, filed with the China National Intellectual Property Administration on Dec. 13, 2022, which is incorporated herein by reference in its entirety.

### TECHNICAL FIELD

The present disclosure relates to the field of magnet materials, and particularly, to an R-T-B based permanent magnet material, a preparation method therefor and use thereof.

### BACKGROUND

The permanent magnet material is also called hard magnetic material, and is characterized by high anisotropy field, high coercivity, large hysteresis loop area, large magnetization field required for magnetization to saturation, and capability of keeping strong magnetism for a long time after an external magnetic field is removed. Among permanent magnet materials, sintered neodymium-iron-boron (NdFeB) based permanent magnets have more outstanding magnetic property advantages than other permanent magnet materials. For example, the sintered NdFeB based permanent magnets have higher magnetic energy product, coercivity and energy density, have good mechanical property, and are easy to process. These excellent properties make the sintered NdFeB permanent magnets widely used in modern industry and electronics, more commonly in motors, loudspeakers, magnetic separators, computer disk drives, magnetic resonance imaging devices, and the like.

As rare earth elements, the main component, of the NdFeB magnet are easy to oxidize, the magnetic property of the magnet will be reduced if a large amount of oxygen is added in the preparation process, and thus the influence of the oxygen content on the magnetic property can be improved by controlling the oxygen content. The method for controlling the oxygen content has become one of important directions in the prior art. In the process of manufacturing a sintered NdFeB permanent magnet material, oxygen inevitably enters the sintered NdFeB magnet from the atmosphere. However, there is a great difference in the methods for controlling the oxygen content in the prior art. For example, patent document CN111554499A discloses that when the oxygen content of the sintered magnet is too high, in one aspect, the overall magnetic property thereof may be reduced by the addition of non-magnetic phase oxygen; in another aspect, after the oxygen atoms enter the magnet, crack starting points are easily formed, and thus the use of the magnet in a severe service environment is seriously influenced. Therefore, in the document, the blank after the orientation molding is subjected to a hot-pressing densification process, such that the density of the pre-sintered blank is improved, the pores in the blank are greatly reduced, and most impurity gases in the sintering process flow are discharged, thereby reducing the oxygen content of the sintered NdFeB permanent magnet. For another example, patent document CN112614685A further indicates that no oxygen is added in the jet milling process, but an antioxidant is added in the coarse powder, and water is added to supplement oxygen after the fine powder is prepared. After the water and the fine powder are uniformly mixed, oxygen generated by decomposition during the sintering process is uniformly combined with the NdFeB, thereby achieving the control of the oxygen content of the NdFeB magnet.

As the method described above only considers the control of the oxygen content of the ambient atmosphere in the process and the control method is complicated, further development of a sintered NdFeB based permanent magnet and a preparation method therefor is required to improve the technical problems described above.

### SUMMARY

In order to solve the problems described above, the present disclosure provides an R-T-B based permanent magnet material, wherein the R is selected from one, two, or more of neodymium (Nd), praseodymium (Pr), gadolinium (Gd), holmium (Ho), dysprosium (Dy), and terbium (Tb); the T comprises at least iron (Fe); the B is boron;
the permanent magnet material further comprises M, wherein the M is selected from one or more of transition metal elements, low-melting-point metal elements, non-metal elements, and light rare earth elements; and
an M oxide is present in a grain boundary phase of the permanent magnet material.

According to an embodiment of the present disclosure, the R is preferably selected from Nd and NdPr.

According to an embodiment of the present disclosure, the T is preferably selected from iron (Fe) and a mixture thereof with another metal element. The another metal may be selected from one or more of transition metal elements other than iron.

The transition metal elements in the context of the present disclosure have the meaning well known in the art and refer to the metal elements of regions d and ds in the periodic table of elements, wherein the elements of region d include elements of groups IIIB to VIIB, VIII, but exclude lanthanides and actinides; the elements of region ds include elements of groups IB to IIB. Generally, the transition metal elements include elements of a total of ten groups of 3 to 12, but exclude internal transition elements of region f (elements No. 58 to 71 in the periodic table are called internal transition elements of 4f, and elements No. 90 to 103 are called internal transition elements of 5f, all of which are elements of region f).

According to an embodiment of the present disclosure, the low-melting-point metal may be selected from metals having a melting point not more than 1300° C., and an example thereof may be one or more of copper (Cu), gallium (Ga), aluminum (Al), zirconium (Zr), titanium (Ti), tin (Sn), and manganese (Mn).

According to an embodiment of the present disclosure, the light rare earth element may be selected from one or more of elements such as lanthanum (La), cerium (Ce), praseodymium (Pr), neodymium (Nd), promethium (Pm), samarium (Sm), europium (Eu), and the like.

According to an embodiment of the present disclosure, the M may be selected from one or more of Cu, Ga, Al, Zr, Ti, Sn, Mn, B, V, and Se, such as one or more of Cu, Ga, Al, Zr, Ti, Sn, Mn, and Se, preferably one or more of B, Cu, Ga, Al, Sn, and Mn.

According to an embodiment of the present disclosure, the mass percentage of the R is not less than 28.5% and not more than 32.5%, for example, 29.0%, 29.5%, 30.0%, 30.5%, 31.0%, 31.5%, 32.0%, or 32.5%, based on the mass of the permanent magnet material.

According to an embodiment of the present disclosure, the mass percentage of the B is not less than 0.88% and not more than 1.05%, for example, 0.90%, 0.95%, 0.98%, 1.00%, or 1.05%, based on the mass of the permanent magnet material.

According to an embodiment of the present disclosure, the total mass percentage of the M is not less than 0.1% and not more than 4.0%, preferably not less than 0.15% and not more than 2.5%, for example, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 2.0%, 2.5%, 3.0%, 3.5%, or 4.0%, based on the mass of the permanent magnet material.

According to an embodiment of the present disclosure, the permanent magnet material may comprise Co. For example, the mass percentage of the Co is not less than 0% and not more than 0.7%, more preferably not less than 0.1% and not more than 0.5%, based on the mass of the permanent magnet material. As an example, the mass percentage of the Co may be 0.05%, 0.1%, 0.15%, 0.2%, 0.25%, 0.3%, 0.35%, 0.4%, 0.45%, or 0.5%.

According to an embodiment of the present disclosure, the balance of the permanent magnet material is Fe, O, and an inevitable impurity, wherein the inevitable impurity is, for example, at least one of C, N, and the like.

According to an embodiment of the present disclosure, the mass percentage of the O is 700 to 4000 ppm, for example, 700 ppm, 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3100 ppm, 3200 ppm, 3300 ppm, 3400 ppm, 3500 ppm, 3600 ppm, 3700 ppm, 3800 ppm, 3900 ppm, or 4000 ppm, based on the mass of the permanent magnet material. Preferably, the mass percentage of the O is 700 to 2000 ppm.

According to an embodiment of the present disclosure, an R-M-O rich phase is present in the grain boundary phase, preferably at a grain boundary triple point, of the permanent magnet material.

According to an embodiment of the present disclosure, in the grain boundary phase, preferably at the grain boundary triple point, of the permanent magnet material, the sum of the mass percentages of M and oxygen is not less than 20%, preferably not less than 40%. For example, the mass percentage of the M at the grain boundary triple point is 15% to 45%, preferably 20% to 40%, such as 30% to 35%, and an example thereof may be 32%; for another example, the mass percentage of the oxygen at the grain boundary triple point is 5% to 15%, preferably 6% to 12%, such as 7% to 10%, and an example thereof may be 8%.

According to an embodiment of the present disclosure, the ratio of the mass percentages of the O at the grain boundary triple point to the O at a two-crystal grain boundary, of the permanent magnet material, is greater than 1, preferably not less than 1.5, for example, 1.5, 2, 2.5, or 3.

According to an embodiment of the present disclosure, when present, the mass percentage of the C is 400-800 ppm, based on the mass of the permanent magnet material.

According to an embodiment of the present disclosure, the grain boundary of the permanent magnet material may further comprise an M compound selected from, for example, one or more of compounds M-C and M-B.

According to an embodiment of the present disclosure, the permanent magnet material further comprises a heavy rare earth element (HRE), wherein the heavy rare earth element has a meaning well known in the art, and an example thereof may be selected from gadolinium (Gd), terbium (Tb), dysprosium (Dy), holmium (Ho), erbium (Er), thulium (Tm), ytterbium (Yb), lutetium (Lu), and yttrium (Y).

According to an embodiment of the present disclosure, the crystal grain size of the permanent magnet material is not more than 6 μm, for example, 0.1 μm to 6 μm, such as 0.1 μm, 0.5 μm, 1.0 μm, 1.5 μm, 3.0 μm, 4.5 μm, or 6.0 μm.

In the context of the present disclosure, when a range of values is described as “not less than” or “not more than” a certain value, it should be understood that the range includes the value itself. In other words, when “not less than a certain value” is described, it means that the range of values is “not less than the value”, i.e., the range includes the certain value itself and values greater than the value; when “not more than a certain value” is described, it means that the range of values is “not more than the value”, i.e., the range includes the certain value itself and values smaller than the value.

The present disclosure further provides a metal composition, wherein the composition comprises metals R, T, and B as matrices, and M oxides present in the matrices.

According to an embodiment of the present disclosure, the composition is present in the form of a powder. The particle size of the powder may be not more than 500 μm, for example, 1 μm to 300 μm, preferably 1 μm to 50 μm, more preferably 3 μm to 40 μm, and an example thereof may be 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, or 100 μm.

According to an embodiment of the present disclosure, the mass percentage of the M oxides is not less than 0.05% and not more than 5.00%, preferably not less than 0.10% and not more than 3.00%, based on the mass percentage of the matrices in the composition, and an example thereof may be 0.05%, 0.10%, 0.20%, 0.30%, 0.40%, 0.50%, 0.60%, 0.70%, 0.80%, 0.90%, 1.00%, 1.50%, 2.00%, 2.50%, 3.00%, 3.50%, 4.00%, 4.50%, or 5.00%.

According to an embodiment of the present disclosure, the matrices may further comprise an inevitable impurity, wherein the inevitable impurity is, for example, at least one of C, N, and the like.

The present disclosure further provides a sintered material comprising the metal composition sintered. The present disclosure further provides a permanent magnet comprising the sintered material subjected to a heat treatment, and a heavy rare earth element adhered to the sintered material and subjected to a heat treatment.

The present disclosure further provides a permanent magnet comprising a sintered material obtained from the metal composition subjected to sintering and a heat treatment, and a heavy rare earth element adhered to the sintered material and subjected to a heat treatment.

According to an embodiment of the present disclosure, the method for preparing the sintered material comprises molding the metal composition into a molded body, and then sintering the molded body to obtain the sintered material.

According to an embodiment of the present disclosure, the molding step or the sintering step may be performed using conditions known in the art.

According to an embodiment of the present disclosure, in the molding step, a mixture of the metal composition may be dry-molded. For example, a mold disposed in a magnetic field is filled with the mixture of the metal composition followed by pressurization to mold the mixture of the metal composition into a molded body. In this case, by applying a magnetic field while molding, the mixture of the metal composition may be molded with the crystallographic axes being oriented in a specific direction. In the molding step, a molding adjuvant known in the art may be added as needed.

Preferably, the pressure during pressurization may be, for example, not less than 30 MPa and not more than 300 MPa; the applied magnetic field may be a static magnetic field and/or a pulsed magnetic field, and the magnetic field intensity thereof may be, for example, not less than 1000 kA/m and not more than 1600 kA/m. Alternatively, wet molding may be adopted, and specifically, a mixture of the metal composition is dispersed in a slurry of a solvent such as oil, followed by molding.

It should be understood by those skilled in the art that the specific shape of the molded body is not particularly limited, and may be adjusted according to the application conditions of the R-T-B based permanent magnet material. For example, the molded body may have a rectangular parallelepiped shape, a flat plate shape, a columnar shape, a ring shape, a C-shape, or the like.

According to an embodiment of the present disclosure, in the sintering step, the obtained molded body is sintered under vacuum or under an inert gas atmosphere. As an example, the sintering temperature may be not less than 1000° C. and not more than 1150° C., or not less than 1050° C. and not more than 1130° C. The sintering time is not particularly limited, and may be, for example, not less than 2 hours and not more than 10 hours, or not less than 2 hours and not more than 8 hours. The atmosphere during sintering is not particularly limited. For example, the atmosphere may be an inert atmosphere, a vacuum atmosphere of less than 100 Pa, or a vacuum atmosphere of less than 10 Pa. After the molded body is sintered to obtain a sintered body, it may be cooled. The cooling rate is not particularly limited, but the sintered body may be rapidly cooled, for example, at a rate of not less than 20° C./min, in order to improve the productivity.

According to an embodiment of the present disclosure, the surface of the sintered material is coated with the heavy rare earth element subjected to the heat treatment to form a coating layer.

According to an embodiment of the present disclosure, the heat treatment includes a thermal diffusion treatment and a tempering treatment.

According to an embodiment of the present disclosure, the thermal diffusion treatment is a grain boundary diffusion treatment, and the treatment method thereof is a process known in the art. The temperature of the thermal diffusion treatment may be not less than 800° C., for example, 850° C. to 950° C., and an example thereof may be 800° C., 810° C., 820° C., 830° C., 840° C., 850° C., 860° C., 870° C., 880° C., 890° C., or 900° C. The time for the thermal diffusion treatment may be not less than 5 hours, for example, 10 hours to 50 hours, such as 10 hours, 15 hours, 20 hours, 25 hours, 30 hours, 35 hours, 40 hours, 45 hours, or 50 hours.

According to an embodiment of the present disclosure, the temperature of the tempering treatment may be not more than 700° C., for example, 450° C. to 650° C., and an example thereof may be 450° C., 460° C., 470° C., 480° C., 490° C., 500° C., 510° C., 520° C., 530° C., 540° C., 550° C., 560° C., 570° C., 580° C., 590° C., 600° C., 610° C., 620° C., 630° C., 640° C., or 650° C. The time for the tempering treatment may be not less than 1 hour, for example, 1 hour to 10 hours, and an example thereof may be 1 hour, 2 hours, 3 hours, 4 hours, 5 hours, 6 hours, 7 hours, 8 hours, 9 hours, or 10 hours.

The present disclosure further provides a method for preparing the R-T-B based permanent magnet material, which comprises:
molding the metal composition into a molded body of the metal composition;
sintering the molded body to obtain a sintered substrate comprising the metal composition; and enabling a heavy rare earth element to be in contact with the sintered substrate comprising the metal composition; wherein
preferably, the heavy rare earth element is in contact with the sintered substrate comprising the metal composition to form a coating layer of the heavy rare earth element on the surface of the substrate.

The present disclosure further provides a method for preparing the metal composition, which comprises: enabling the metal composition to be in contact with one or more of the M oxides.

According to an embodiment of the present disclosure, the powder of the metal composition and a substance selected from one or more of M and M compounds may be prepared by a powdering process known in the art. The powdering process may be selected from a powder metallurgy process and a hydrogen decrepitation and jet milling process.

According to an exemplary embodiment of the present disclosure, the powder metallurgy process may comprise the steps of performing rapid solidification or arc smelting on the starting materials, performing hydrogen decrepitation, and then performing high-energy ball milling, and the like. The hydrogen decrepitation and jet milling process may comprise the steps of performing rapid solidification or arc smelting on the starting materials, performing hydrogen decrepitation, and then performing jet milling process, and the like.

According to an exemplary embodiment of the present disclosure, in the step of preparing the metal composition, the M oxides are mixed with the metals R, T, and B which are the matrices before hydrogen decrepitation.

The present disclosure further provides use of the Re—Fe—B based permanent magnet material described above in the fields of motors, loudspeakers, magnetic separators, computer disk drivers, magnetic resonance imaging devices, and the like, preferably use thereof as a motor rotor steel magnet in motors.

### Advantageous Effect

The inventors have surprisingly found that although increasing the oxygen content in the permanent magnet material may improve the thermal weight loss and the corrosion resistance, a significant decrease in magnetic property will be caused if the oxygen content is too high. The R-T-B permanent magnet material of the present disclosure forms M oxides at the grain boundary triple point, such that oxygen is enriched at the grain boundary triple point, thereby accurately controlling the oxygen content in the magnet. The permanent magnet material of the present disclosure can improve the corrosion resistance and the formability in the pressing and molding process under the condition of unchanged magnetic property, thereby improving the application performance and the qualified rate of products.

### BRIEF DESCRIPTION OF THE DRAWINGS

FIG. 1 is an EMPA analysis diagram of the permanent magnet material sample F13 prepared in Example 3, in which M oxides are present at the grain boundary triple points.

FIG. 2 is an EMPA analysis diagram of the permanent magnet material sample F0 prepared in Comparative Example 1.

FIG. 3 is an EPMA diagram of the permanent magnet material sample F13 prepared in Example 3, in which the O content was subjected to line scan analysis.

FIG. 4 is an EPMA diagram of the permanent magnet material sample F0 prepared in Comparative Example 1, in which the O content was subjected to line scan analysis.

### DETAILED DESCRIPTION

The embodiments of the present disclosure will be further illustrated in detail with reference to the following specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the starting materials and reagents used in the following examples are all commercially available products, or can be prepared using known methods.

### Instruments and Methods

### [EMPA Assay]

The instrument was an EPMA-1720 type electron probe microscope manufactured by Shimadzu corporation, Japan.

The test conditions were as follows: the accelerating voltage was 10 kV, the beam current was 20 nA, the test time for elements B and O was 30 s, the time for background test was 10 s, and the time for other elements was default to be 10 s.

### [Magnetic Property Test]

The instrument was an NIM-62000 type rare earth permanent magnet measuring system from the National Institute of Metrology.

The test conditions were as follows: a closed-loop test was carried out at 20-200° C.

### [Weight Loss Performance Test]

The instrument was a D10-10 sample column, Germany HAST high-temperature and high-humidity tester.

The test conditions were as follows: 130° C., 0.26 atm, 100% RH, and 480 h.

### Preparation Example 1: Preparation of Nd—Fe—B Scales

Vacuum smelting and melt-spinning were adopted to give neodymium-iron-boron (Nd—Fe—B) scale samples A1, A2, A3, A4, and A5.

Through measurement, the mass percentage of each element is shown in the following table:

| Sample | Nd % | Pr % | B % | Co % | Ti % | Cu % | Zr % | Ga % | Al % | Fe % |
|---|---|---|---|---|---|---|---|---|---|---|
| A1 | 23.9 | 6.0 | 0.98 | 0.5 | 0.18 | 0.20 | 0.02 | 0.20 | 0.05 | Balance |
| A2 | 23.9 | 6.0 | 0.98 | 0.1 | 0.18 | 0.20 | 0.02 | 0.20 | 0.05 | Balance |
| A3 | 23.9 | 6.0 | 0.98 | 1.0 | 0.18 | 0.20 | 0.02 | 0.20 | 0.05 | Balance |
| A4 | 23.9 | 6.0 | 0.98 | 1.5 | 0.18 | 0.20 | 0.02 | 0.20 | 0.05 | Balance |
| A5 | 23.9 | 6.0 | 0.95 | 0.5 | 0.18 | 0.20 | 0.02 | 0.20 | 0.05 | Balance |

### Preparation Example 2: Preparation of Coarse Nd—Fe—B Powders

The Nd—Fe—B scales in Preparation Example 1 were subjected to hydrogen decrepitation to give coarse Nd—Fe—B powder samples B1, B2, B3, B4, and B5.

### Preparation Example 3: Preparation of M Oxide Powders

The M compounds shown in the following table were each subjected to liquid phase precipitation to give oxide precipitates which were filtered, washed, dried, calcined, and thermally decomposed to give the following powder samples.

| Powder sample | M compound | Particle size (μm) |
|---|---|---|
| C1 | B₂O | 3 |
| C1-1 | B₂O | 1 |
| C1-2 | B₂O | 40 |
| C1-3 | B₂O | 0.3 |
| C1-4 | B₂O | 50 |
| C2 | Al₂O₃ | 3 |
| C3 | CuO | 3 |
| C4 | MgO | 3 |
| C5 | ZrO | 3 |
| C6 | V₂O₅ | 3 |

### Example 1: Preparation of Mixture of Nd—Fe—B Based Alloy Powders

The samples obtained in Preparation Example 1 and the samples obtained in Preparation Example 3 were respectively mixed and homogenized, and then were subjected to hydrogen decrepitation and jet milling to give fine-grained powders, such that the surfaces of the Nd—Fe—B powders were completely coated with M oxides to form coating layers of the M oxide compounds; or the samples obtained in Preparation Example 2 and the samples obtained in Preparation Example 3 were mixed uniformly, and then the surfaces of the Nd—Fe—B powders were completely coated with M oxides to form coating layers of the M oxide compounds. The specific samples are shown in the following table:

(1) The Addition Amounts were Different:

| | |
|---|---|
| Sample in Preparation | Sample in Preparation |
| Example 1 | Example 3 |

| Sample | Species | Content | Species | Content |
|---|---|---|---|---|
| D1 | A1 | 100 g | C1 | 0.2 g |
| D2 | A1 | 100 g | C1 | 1 g |
| D3 | A1 | 100 g | C1 | 0.1 g |
| D4 | A1 | 100 g | C1 | 1.5 g |

### (2) Influence of Substrates

| | |
|---|---|
| Sample in Preparation | Sample in Preparation |
| Example 1 | Example 3 |

| Sample | Species | Content | Species | Content |
|---|---|---|---|---|
| D5 | A1 | 100 g | C1 | 0.3 g |
| D6 | A2 | 100 g | C1 | 0.3 g |
| D7 | A3 | 100 g | C1 | 0.3 g |
| D8 | A4 | 100 g | C1 | 0.3 g |
| D9 | A5 | 100 g | C1 | 0.3 g |

### (3) Difference of M Oxides

| | |
|---|---|
| Sample in Preparation | Sample in Preparation |
| Example 1 | Example 3 |

| Sample | Species | Content | Species | Content |
|---|---|---|---|---|
| D10 | A1 | 100 g | C2 | 0.3 g |
| D11 | A1 | 100 g | C3 | 0.3 g |
| D12 | A1 | 100 g | C4 | 0.3 g |
| D13 | A1 | 100 g | C5 | 0.3 g |
| D14 | A1 | 100 g | C6 | 0.3 g |

### (5) Influence of Particle Size

| | |
|---|---|
| Sample in Preparation | Sample in Preparation |
| Example 1 | Example 3 |

| Sample | Species | Content | Species | Content |
|---|---|---|---|---|
| D15 | A1 | 100 g | C1-1 | 0.3 g |
| D16 | A1 | 100 g | C1-2 | 0.3 g |
| D17 | A1 | 100 g | C1-3 | 0.3 g |
| D18 | A1 | 100 g | C1-4 | 0.3 g |

### (6) Influence of Mixing Timing

| | |
|---|---|
| Sample in Preparation | Sample in Preparation |
| Example 2 | Example 3 |

| Sample | Species | Content | Species | Content |
|---|---|---|---|---|
| D19 | B1 | 100 g | C1 | 0.3 g |
| D20 | B2 | 100 g | C1 | 0.3 g |
| D21 | B3 | 100 g | C1 | 0.3 g |
| D22 | B4 | 100 g | C1 | 0.3 g |
| D23 | B5 | 100 g | C1 | 0.3 g |

### Example 2: Preparation of Sintered Body of Nd—Fe—B Based Alloy Powder Mixture

Samples D1-D23 in Example 1 were processed as follows to give sintered body samples E1-E23 of the Nd—Fe—B based alloy powder mixture, respectively:
(1) Molding: Samples D1-D23 in Example 1 were respectively compression-molded in an oriented magnetic field to form pressed compacts with a density of 3.6-4.2 g/cm³, wherein the field intensity of the oriented magnetic field was 2-8 T, then the pressed compacts were subjected to isostatic pressing to obtain a further increased density, and then pressed compacts of samples D1-D23 without fine cracks inside were formed.
(2) Sintering: The pressed compacts of samples D1-D23 in the step (1) were respectively sintered under vacuum with the sintering temperature controlled within a range of 1080-1100° C. and the sintering time controlled within 2-10 h, and the sintered magnets were cooled to give sintered body samples E1-E23.

### Example 3: Preparation of Nd—Fe—B Based Permanent Magnet Material

The sintered body samples E1-E23 prepared in Example 2 were processed as follows to give Nd—Fe—B based permanent magnet material samples F1-F23:

(1) Coating with Heavy Rare Earth Components

Dy—Fe alloy powders or Tb—Fe alloy powders with a certain mass were mixed uniformly into a specific solvent to give a heavy rare earth coating slurry, the surface of each sintered sample was coated with the heavy rare earth coating slurry uniformly, and the sample was dried to give a uniform and flat heavy rare earth alloy powder coating layer.

### (2) Thermal Diffusion Treatment

The Nd—Fe—B sintered body samples with the surfaces adhered with the heavy rare earth alloy were placed into a vacuum sintering furnace for thermal diffusion treatment, wherein the diffusion temperature was 910° C. or 890° C., and the diffusion time was 20-35 h.

### (3) Tempering Treatment

The tempering treatment was carried out at a tempering temperature of 480-550° C. for 4 h to give the Nd—Fe—B based permanent magnet material samples F1-F23.

### Comparative Example

Referring to the method for preparing the Nd—Fe—B based permanent magnet material sample F1, the difference was that the Nd—Fe—B based permanent magnet material sample F0 was obtained after the steps of molding, sintering, diffusing, and tempering were carried out without adding M oxide powders.

### Test Example 1: EMPA Analysis of Permanent Magnet Material

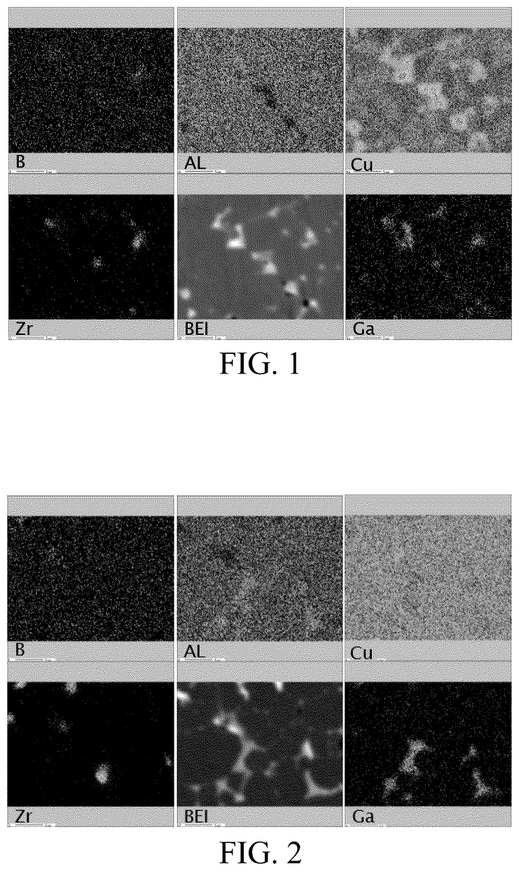

EPMA test was conducted on the Nd—Fe—B based permanent magnet material sample F13 obtained in Example 3 and sample F0 obtained in Comparative Example as described above, and the results are shown in FIGS. 1 and 2, where it can be seen that the sample having the M oxide powders added had a large amount of Cu enriched at the grain boundaries, indicating that the content of the M (Cu) oxide was relatively high; sample F1 had an M (Cu) content of 32% and an O content of 8% at the grain boundary triple points.

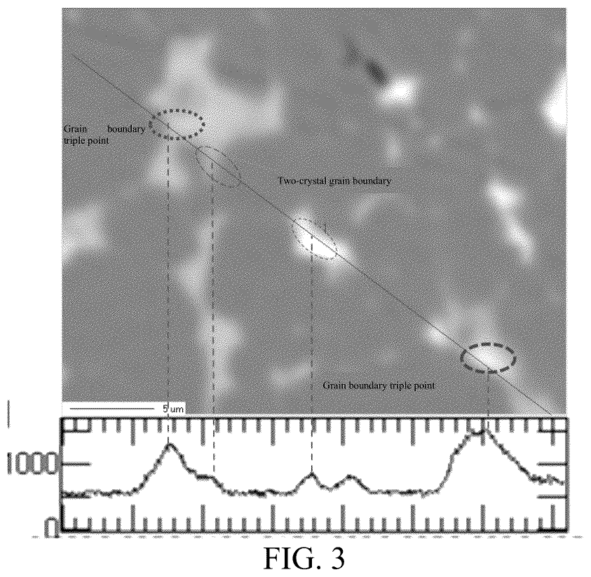

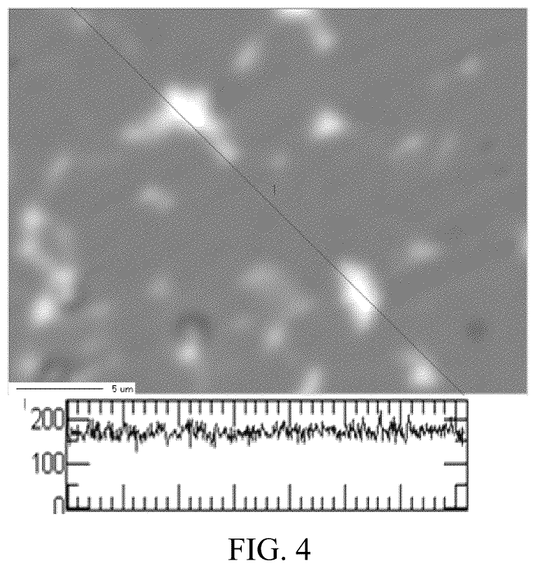

Electron probe micro-analysis (EPMA) was performed on samples F13 and F0 to conduct line scan analysis on the O content, and the results are shown in FIGS. 3 and 4, where it can be seen that the proportion of the O content at the grain boundary triple points in the sample having the M oxide powders added was more than 1.5 times of the proportion of the O content at the two-crystal grain boundaries, while the O content in different positions in the sample having no M oxide powders added had no significant trend of change.

### Test Example 2: Magnetic Property and Weight Loss Performance Tests of Permanent Magnet Material

The magnetic property, the oxygen content, and the weight loss performance of the Nd—Fe—B based permanent magnet material samples F1-F23 obtained in Example 3 and sample F0 obtained in Comparative Example as described above were measured, and the results are as follows:

| | | | | O content | |
|---|---|---|---|---|---|
| | Br | Hcj | BH₍ₘₐₓ₎ | in sample | Weight loss |
| Sample | (KGs) | (Koe) | (MGOe) | (ppm) | (mg/cm²) |
| F1 | 1.434 | 2020 | 399.8 | 777 | 0.10 |
| F2 | 1.432 | 1975 | 387.7 | 1434 | 0.14 |
| F3 | 1.434 | 2079 | 397.3 | 406 | 0.55 |
| F4 | 1.425 | 1908 | 387.7 | 2739 | 0.19 |
| F5 | 1.439 | 2048 | 402.4 | 844 | 0.07 |
| F6 | 1.439 | 2045 | 402.4 | 851 | 0.05 |
| F7 | 1.437 | 2010 | 401.6 | 831 | 0.05 |
| F8 | 1.432 | 2000 | 398.8 | 858 | 0.02 |
| F9 | 1.437 | 2043 | 401.4 | 829 | 0.07 |
| F10 | 1.429 | 1883 | 397.7 | 1012 | 0.05 |
| F11 | 1.435 | 2018 | 397.9 | 763 | 0.10 |
| F12 | 1.420 | 2051 | 390.3 | 844 | 0.05 |
| F13 | 1.415 | 1923 | 387.8 | 527 | 0.44 |
| F14 | 1.425 | 1925 | 393.3 | 1001 | 0.26 |
| F15 | 1.423 | 2048 | 393 | 848 | 0.07 |
| F16 | 1.423 | 1995 | 391.9 | 887 | 0.05 |
| F17 | 1.415 | 1978 | 389.0 | 806 | 0.08 |
| F18 | 1.419 | 1967 | 389.1 | 812 | 0.07 |
| F19 | 1.439 | 2048 | 402.4 | 675 | 0.12 |
| F20 | 1.439 | 2045 | 402.4 | 634 | 0.11 |
| F21 | 1.437 | 2040 | 401.6 | 600 | 0.13 |
| F22 | 1.432 | 2044 | 398.8 | 636 | 0.12 |
| F23 | 1.437 | 2043 | 401.4 | 661 | 0.10 |
| F0 | 1.440 | 2055 | 403.1 | 347 | 0.73 |

The results are brought to the following conclusion.

Comparison of samples F1-F4 shows that although the oxygen content in the magnet increased significantly with increased amount of M oxide powders added, a relatively high level of the oxygen content could lead to a decrease in the magnetic property of the magnet and also affected the corrosion resistance of the magnet; when the amount of M oxide powders added was relatively small, the content of the M oxide structures formed at the grain boundary triple points was insufficient, and the oxygen content was not uniformly distributed in the magnet, so that the effect for improving the corrosion resistance of the low-Co product was not significant.

Comparison of samples F5-F9 shows that the Co content had a significant effect for improving the corrosion resistance of the magnet, but an increase in the Co content exhibited a weakening effect on the Hcj of the magnet, and meanwhile, taking into account that Co was a strategic material, the addition of the M oxide powders could also achieve the effect for improving the corrosion resistance of the magnet.

Comparison of samples F1 and F10-F14 shows that different M oxides provided different oxygen contents due to their different mass fractions, and meanwhile, due to different thicknesses of coating layers of the oxides, the effects of the oxides were significantly different, wherein the effects of B20, CuO, and MgO were better.

Comparison of samples F1 and F15-F18 shows that M oxide powders with different particle sizes would also cause differences in property and corrosion resistance, and if the powder particles were too small, the powder particles were easy to agglomerate, which affected the mixing effect of the magnet powders and the oxide powders, resulting in non-uniform mixing; then, oxygen-enriched regions were formed on the grain boundaries, and thus the property of the magnet were influenced; if the powder particles were too large, the presenclaimce of more M oxides would hinder the liquid flow of the neodymium-rich phase during the heat treatment, making the grain boundaries discontinuous, thereby affecting the magnetic property and corrosion resistance.

Comparison of samples F1-F5 and F19-F23 shows that the effect of the M oxide powders added before hydrogen decrepitation (HD) was better than that of the M oxide powders added after HD, and the high-temperature environment could promote the rare earth elements to react with M oxides in the HD process, such that the oxygen element was retained at the grain boundaries in the form of a compound, and after HD, the possibility of agglomeration and non-uniformity was still present after the magnet powders were mixed with the oxide powders, and thus the oxygen content at the grain boundary triple points was lower.

Comparison of samples F1 and F0 shows that the permanent magnet material samples of the present disclosure formed MO compounds at the grain boundary triple points, such that oxygen was enriched at the grain boundary triple points, thereby controlling the oxygen content in the magnet.

The above examples illustrate the embodiments of the present disclosure. However, the protection scope of the present disclosure is not limited to the embodiments described above. Any modification, equivalent replacement, improvement, and the like made by those skilled in the art without departing from the spirit and principle of the present disclosure shall fall within the protection scope of the present disclosure.

1. An R-T-B based permanent magnet material, wherein the R is selected from one, two, or more of neodymium (Nd), praseodymium (Pr), gadolinium (Gd), holmium (Ho), dysprosium (Dy), and terbium (Tb); the T comprises at least iron (Fe); the B is boron;
the permanent magnet material further comprises M, wherein the M is selected from one or more of transition metal elements, low-melting-point metal elements, non-metal elements, and light rare earth elements; and
an M oxide is present in a grain boundary phase of the permanent magnet material;
preferably, the balance of the permanent magnet material is Fe, O, and an inevitable impurity; more preferably, the mass percentage of the O is 700 to 4000 ppm, based on the mass of the permanent magnet material.

2. The R-T-B based permanent magnet material according to claim 1, wherein
the low-melting-point metal can be selected from metals having a melting point not more than 1300° C., and an example thereof can be one or more of copper (Cu), gallium (Ga), aluminum (Al), zirconium (Zr), titanium (Ti), tin (Sn), and manganese (Mn);
the light rare earth element can be selected from one or more of elements such as lanthanum (La), cerium (Ce), praseodymium (Pr), neodymium (Nd), promethium (Pm), samarium (Sm), europium (Eu), and the like;
preferably, the M is selected from one or more of Cu, Ga, Al, Zr, Ti, Sn, Mn, B, V, and Se.

3. The R-T-B based permanent magnet material according to claim 1, wherein
the mass percentage of the R is not less than 28.5% and not more than 32.5%, based on the mass of the permanent magnet material;
the mass percentage of the B is not less than 0.88% and not more than 1.05%, based on the mass of the permanent magnet material;
the total mass percentage of the M is not less than 0.1% and not more than 4.0%, preferably not less than 0.15% and not more than 2.5%, based on the mass of the permanent magnet material;
preferably, the permanent magnet material comprises Co; for example, the mass percentage of the Co is not less than 0% and not more than 0.7%, more preferably not less than 0.1% and not more than 0.5%, based on the mass of the permanent magnet material.

4. The R-T-B based permanent magnet material according to claim 1, wherein the mass percentage of the O is 700 to 2000 ppm, based on the mass of the permanent magnet material.

5. The R-T-B based permanent magnet material according to claim 1, wherein an R-M-O rich phase is present in the grain boundary phase, preferably at a grain boundary triple point, of the permanent magnet material;
preferably, in the grain boundary phase, preferably at the grain boundary triple point, of the permanent magnet material, the sum of the mass percentages of the M and the oxygen is not less than 20%, preferably not less than 40%;
more preferably, the ratio of the mass percentages of the O at the grain boundary triple point to the O at a two-crystal grain boundary, of the permanent magnet material, is greater than 1, preferably not less than 1.5.

6. A metal composition, wherein the composition comprises metals R, T, and B as matrices, and M oxides present in the matrices;
preferably, the composition is present in the form of a powder; the particle size of the powder can be not more than 500 μm, for example, 1 μm to 300 μm, preferably 1 μm to 50 μm;
preferably, the mass percentage of the M oxides is not less than 0.05% and not more than 5.00%, preferably not less than 0.10% and not more than 3.00%, based on the mass percentage of the matrices in the composition.

7. A permanent magnet, comprising a sintered material obtained from the metal composition according to claim 6 subjected to sintering and a heat treatment, and a heavy rare earth element adhered to the sintered material and subjected to a heat treatment.

8. A method for preparing the R-T-B based permanent magnet material according to claim 1, comprising:
molding the metal composition comprises metals R, T, and B as matrices, and M oxides present in the matrices into a molded body of the metal composition, wherein the metal composition comprises metals R, T, and B as matrices, and M oxides present in the matrices;
sintering the molded body to obtain a sintered substrate comprising the metal composition; and
enabling a heavy rare earth element to be in contact with the sintered substrate comprising the metal composition; wherein
preferably, the heavy rare earth element is in contact with the sintered substrate comprising the metal composition to form a coating layer of the heavy rare earth element on the surface of the substrate.

9. The method according to claim 8, further comprising a step of preparing the metal composition, wherein the M oxides are mixed with the metals R, T, and B which are the matrices before hydrogen decrepitation.

10. Use of the R-T-B based permanent magnet material according to claim 1 in the fields of motors, loudspeakers, magnetic separators, computer disk drives, and magnetic resonance imaging devices, preferably use thereof as a motor rotor steel magnet in motors.
